(19) United States
(12) Patent Application Publication
(10) Pub. No.: US 2023/0005164 A1
(43) Pub. Date: Jan. 5, 2023

(54) Arrangement for Monitoring State and Sequence of Movement in an Aseptic Work Chamber of a Containment

(71) Applicant: Skan AG, Allschwil (CH)

(72) Inventors: Christoph Joschi Geiser, Möhlin (CH); Frank Martin Lehmann, Binningen (CH)

(73) Assignee: Skan AG, Allschwil (CH)

(21) Appl. No.: 17/774,042

(22) PCT Filed: Oct. 22, 2020
(86) PCT No.: PCT/CH2020/000016

§ 371 Date: May 3, 2022

(30) Foreign Application Priority Data
Nov. 4, 2019 (EP) 19405018.3

(51) Int. Cl. G06T 7/292; B25J 21/02; G06T 7/246; G08B 7/06

(52) U.S. Cl. CPC G06T 7/292; B25J 21/02; G06T 7/251; G08B 7/06; G06V 40/00

(57) ABSTRACT

The arrangement is provided for monitoring state and sequence of movement in an aseptic work chamber of a containment standing in an installation room. At least one work glove projects into the work chamber, wherein the respective work glove is able to stretch up to a maximum grasping range in the three spatial axes in the work chamber. The arrangement comprises a tracking system, the recordings of which serve to continuously localize the at least one work glove in three dimensions and are stored in a computer unit. At least one three-dimensional or two-dimensional prohibited region, which may be adjoined by a warning region, is defined in the work chamber. Individual surface sections or the entire floor of the containment can be defined as a prohibited region. A prohibited region and possibly a warning region in front of this can be set up around machines which are installed in the work chamber and which constitute a danger for the operator. The coordinates of prohibited region and warning region are stored in the computer unit. The at least one work glove must not be used to intervene in the prohibited region and should not be used to intervene in the warning region.

### FIELD OF THE INVENTION

The present invention relates to an arrangement for monitoring a state and movement sequence in an aseptic work chamber of a containment located in an installation room, having at least one work glove which projects into the work chamber. The respective work glove can be extended in the work chamber as far as a maximum gripping range in the three xyz spatial axes. Each work glove could respectively hold an object, or two work gloves together could hold an object, so that there is a maximally extended action range in the three xyz spatial axes. Containers which are filled with substances, are to be filled therewith or are to be emptied, may temporarily be located in the work chamber.

### PRIOR ART

Metall+Plastik GmbH, D-78315 Radolfzell/Germany, discloses the use of cameras for filming the interiors of isolators in order to monitor what is taking place from different directions. The company Nuaire, Plymouth, M.N. 55447/USA, also uses cameras for continuous recording in an isolator (see https://www.nuaire.com/learn/general-technical-bulletins/camera-useage-in-a-biosafety-cabinet-pharmacy-isolator; Internet extract from 30.09.2019).

Ortner Reinraumtechnik GmbH, A-9500 Villach/Austria, uses an intercom system with a monitoring camera for the same purpose (see https://www.ortner-group.com/produkte/isoline/aseptic-isolator.15f08.php; Internet extract from 30.09.2019).

Bausch+Ströbel Maschinenfabrik Ilshofen GmbH+Co. KG, D-74532 Ilshofen/Germany, discloses the use of cameras for continuous monitoring of filling processes in isolators (see ISPE November 2018 “Remote Observation Technologies—Revolutionizing the Pharma Manufacturing Space”, at https://ispe.org/pharmaceutical-engineering/november-december-2018/remote-observation-technologies-revolutionizing; Internet extract from 30.09.2019).

### OBJECT OF THE INVENTION

On the basis of the previously known prior art, the object of the invention is to provide a further developed arrangement for monitoring a state and movement sequence in an aseptic work chamber of a containment. The aim is thereby to ensure safe guiding for the handling operations of the operator at the containment, while nevertheless being able to rapidly detect incorrect activities of the operator and accident events, and to minimize losses resulting therefrom.

### Overview of the Invention

The arrangement is designed for monitoring a state and movement sequence in an aseptic work chamber of a containment located in an installation room. At least one work glove projects into the work chamber, and the respective work glove can be extended in the work chamber as far as a maximum gripping range in the three xyz spatial axes. According to the invention, the arrangement comprises a tracking system, the recordings of which are used for continuous three-dimensional localization of the at least one work glove and are stored in a computer unit. At least one three-dimensional or two-dimensional prohibited region, which may be adjoined by a warning region, is defined in the work chamber. Individual surface sections or the entire bottom of the containment may be defined as a prohibited region. A prohibited region, optionally preceded by a warning region, may be set up around machines which are installed in the work chamber and which represent a hazard for the operator. The coordinates of the prohibited region and warning region are stored in the computer unit. The prohibited region must not be intervened in with the at least one work glove; and the warning region should not be intervened in.

Particular embodiments of the invention will be defined below: each work glove may respectively hold an object, or two work gloves together may hold an object, so that there is a maximally extended action range in the three xyz spatial axes.

The recordings of the tracking system are used for continuous three-dimensional localization both of the at least one work glove and of the at least one object. The prohibited region must also not be intervened in with the object, while the warning region should not be intervened in with the object.

The spatial positions of work gloves and objects within the xyz coordinate system formed by the three spatial axes are recorded with a timestamp in the computer unit; and a real-time comparison with the prohibited regions and optional warning regions established in the computer unit is carried out in the computer unit.

Containers which are filled with substances, are to be filled therewith or are to be emptied, may be temporarily located in the work chamber. The spatial positions of the containers within the xyz coordinate system formed by the three spatial axes are recorded with a timestamp in the computer unit in order, in the event of an accident, to establish an unplanned position of a container, possible breakage of a container with its spreading region and the spreading region of uncontrolledly emerging substance.

Advantageously, the operator is equipped with virtual reality glasses, which are intended:
to display the prohibited regions and optional warning regions defined in the computer unit to them as graphics elements; or also in addition
to display to them a surface to be cleaned according to the cleaning and disinfection program saved in the computer unit.

The tracking system comprises at least a first camera, which has a first acquisition angle, and a second camera, which has a second acquisition angle. The first camera with its first acquisition angle monitoringly records the two xy spatial axes and the second camera with its second acquisition angle monitoringly records the third z spatial axis. The first acquisition angle and the second acquisition angle overlap so that all regions in the work chamber are recorded by the monitoring.

The recorded states and movement sequences are stored as 3D data and/or video streams in the computer unit.

In the case of a large spatial extent of the work chamber, a third camera with its third acquisition angle and—depending on the size of work chamber—further cameras with the respective acquisition angles are installed. The first camera with its first acquisition angle then monitoringly records the x spatial axis, the second camera with its second acquisition angle monitoringly records the y spatial axis and the third camera with its third acquisition angle monitoringly records the z spatial axis. In this case, the acquisition angles overlap in such a way that all regions in the work chamber are recorded by the monitoring. The recorded states and movement sequences are stored as 3D data and/or video streams in the computer unit.

A signal unit is provided, which for an operator intervening in the work chamber and/or a monitoring person:
in the event of unallowed penetration into a prohibited region, alerts them acoustically and/or optically and/or by a vibration acting on the body of the operator and/or of the monitoring person; and
if warning regions are set up, in the event of critical penetration into a warning region as an approach to a prohibited region, informs them acoustically and/or optically and/or by a vibration acting on the body of the operator and/or of the monitoring person.

Further rules are defined in the computer unit, namely:
operators authorized to intervene in the work chamber;
objects, for example tools, allowed in the work chamber and allowed fittable components, for example shaped parts for filling machines, and the specification-compliant installing of such shaped parts in respect of plant-technological allocation and positioning;
maximum allowed speed of the work gloves or objects moved in the work chamber; and
a cleaning and disinfection program.

The tracking system is additionally configured to detect the biometric features of an operator positioned at the containment.

The virtual reality glasses display to the operator, according to the cleaning and disinfection program saved in the computer unit, the prescribed intensity for the surface cleaning, for example as single or multiple wiping to be carried out with a minimum application pressure, and the fulfillment thereof, for example as a color change from red to green when reaching fulfillment.

In one particular embodiment of the monitoring arrangement, the work glove is provided with systematically distributed marking points. With the aid of these marking points, the volume body formed by the work glove can be recorded as a CAD wire model by the tracking system.

The object held by a work glove may likewise be provided with systematically distributed marking points. By means of the marking points, the volume body formed by the object can be recorded as a CAD wire model by the tracking system.

### BRIEF DESCRIPTION OF THE ACCOMPANYING DRAWINGS

The drawings show:

FIG. 1A—the work chamber of a containment with two projecting work gloves, a held object in the form of a tool and two cameras, in a plan view;

FIG. 1B—the structure according to FIG. 1A in a side view;

FIG. 2—a work glove with a tool with a multiplicity of systematic marking points for compiling a CAD wire model;

FIG. 3A—the structure according to FIG. 1A with three cameras and the first work glove with a stretching device, in a plan view;

FIG. 3B—the structure according to FIG. 3A with a user standing in front of the containment, in a side view;

FIG. 4A—the structure according to FIG. 1A, each work glove with a tool, for outline illustration of the gripping and action ranges, in a plan view;

FIG. 4B—shows the structure according to FIG. 4A in a side view;

FIG. 5A—the structure according to FIG. 1A, the second work glove with a tool for outline illustration of warning and forbidden regions, in a plan view;

FIG. 5B—the structure according to FIG. 5A in a side view;

FIG. 6A—the structure according to FIG. 5A for outline illustration with the first work glove engaged in the first forbidden region, in a plan view; and

FIG. 6B—the structure according to FIG. 6A for outline illustration of perturbed laminar flow, in a side view.

### EXEMPLARY EMBODIMENT

With reference to the accompanying drawings, a detailed description is given below of the arrangement according to the invention for monitoring a state and movement sequence in an aseptic work chamber of a containment.

The following statement applies for the entire further description. If a figure contains reference numerals for the sake of graphical clarity, and at the same time it may clearly be seen graphically that they are “recurring” components but they are not explained in the directly associated passage of the description, for the sake of brevity reference is made to the explanation thereof in preceding figure descriptions.

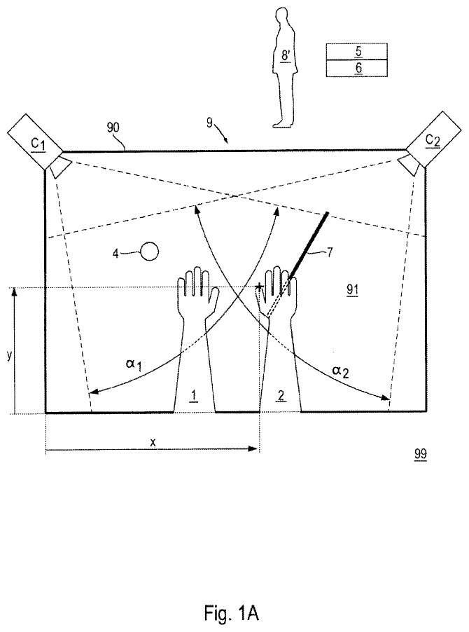

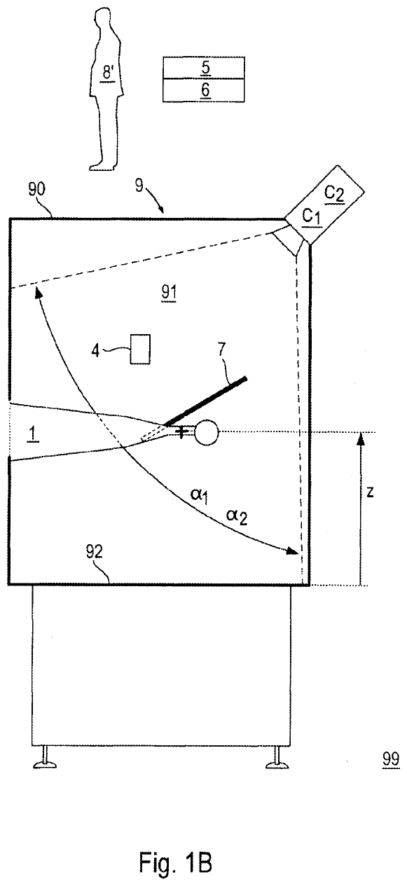

FIGS. 1A and 1B

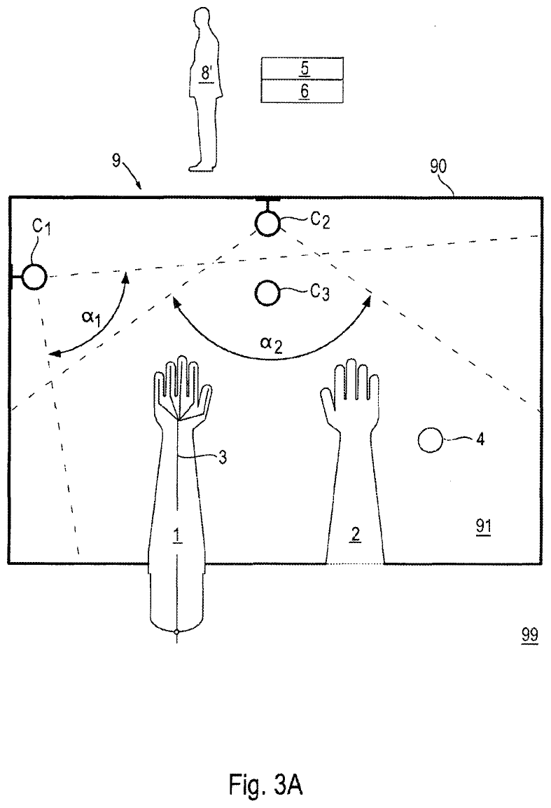

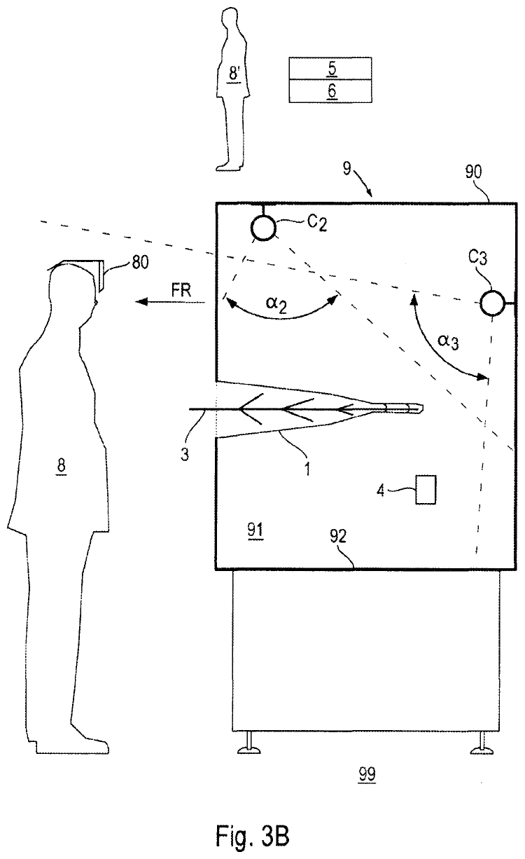

The containment 9 positioned in an installation room 99 is surrounded by the housing 90 which encloses the work chamber 91. A first work glove 1 and a second work glove 2 project—as shown in the extended state—into the work chamber 91. These work gloves 1,2 are intended for intervention by an authorized operator 8 (see FIG. 3B). In order to form a tracking system C1-C2, a first camera C1, which has a first acquisition angle α1, and a second camera C2 with its second acquisition angle α2 are provided. The first camera C1 monitoringly records the two spatial axes x,y and the second camera C2 monitoringly records the third spatial axis z, the first acquisition angle α1 and the second acquisition angle α2 overlapping so that all regions in the work chamber 91 are recorded by the monitoring. The recorded states and movement sequences are stored as 3D data and/or video streams in the computer unit 5.

Instead of by cameras C1,C2, a tracking system C1-C2 may be formed by an apparatus which operates on the basis of optical systems or laser, radar, ultrasound or infrared technology.

Each work glove 1,2 may respectively hold an object 7 or two work gloves 1,2 together may hold an object 7, for example a tool. In the work chamber 91, there may temporarily be containers 4 which are filled with substances, are to be filled therewith or are to be emptied. Outside the containment 9, the computer unit 5 as well as the signal unit 6 are provided and a monitoring person 8′ may be assigned. The monitoring person 8′ will if required intervene in the process sequence at the containment 9.

The recordings of the tracking system C1-C2 in the computer unit 5 are used for continuous three-dimensional localization both of the work glove 1,2 and of the objects 7 guided by the latter in the xyz coordinate system formed by the three spatial axes x,y,z with a timestamp.

In the computer unit 5, the spatial positions of the containers 4 within the xyz coordinate system formed by the three spatial axes x,y,z are also recorded with a timestamp in order, in the event of an accident, to establish an unplanned position of a container 4, possible breakage of a container 4 with its spreading region and the spreading region of uncontrolledly emerging substance. Serious accident events of this type are, for example, plastic or glass containers broken into shards as well as spilled liquid or powder substances.

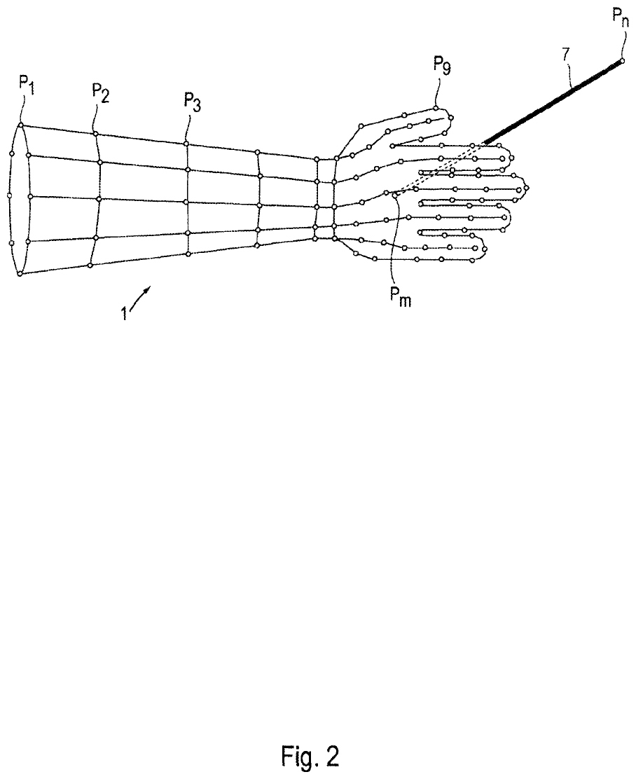

FIG. 2

The work glove 1 is provided with a multiplicity of systematically distributed marking points P1-P9. With the aid of said marking points P1-P9, the volume body formed by the work glove 1 is recorded as a CAD wire model by the tracking system C1-C2. An object 7 which likewise comprises marking points Pm-Pn for position recording by means of the tracking system C1-C2 may be guided with the work glove 1.

FIGS. 3A and 3B

In the case of a large spatial extent of the work chamber 91, a third camera C3 with its third acquisition angle α3 is installed. The first camera C1 with its first acquisition angle α1 monitoringly records the first spatial axis x, the second camera C2 with its second acquisition angle α2 monitoringly records the second spatial axis y and the third camera C3 with its third acquisition angle α3 monitoringly records the third spatial axis z. Depending on the size of work chamber 91, further cameras C with the respective acquisition angles α may be expedient. In this case as well, it is expedient for the acquisition angles α1-αn to overlap in order to record all regions in the work chamber 91 by the monitoring.

Rules may be defined in the computer unit 5, namely:
operators 8 authorized to intervene in the work chamber 91;
objects 7, for example tools, allowed in the work chamber 91 and allowed fittable components, for example shaped parts for filling machines, and the specification-compliant installing of such shaped parts in respect of plant-technological allocation and positioning;
maximum allowed speed of the work gloves 1,2 or objects 7 moved in the work chamber 91; and
a cleaning and disinfection program.

The tracking system C1-C3 may additionally be equipped for face recognition FR with recording of the biometric features of an operator 8 positioned at the containment 9, in order to log the details of the operator 8 and/or establish their authorization for access to the work gloves 1,2, and only to give permission in the event of confirmation, as embodied in the two European Patent Applications No. 19 405 011.8 and 19 405 012.6.

During decontamination to be carried out in the work chamber 91, it is also necessary to ensure that the work gloves 1,2 are fully decontaminated with their sometimes narrow areas, particularly between the fingers, which could not be ensured in the folded, loosely hanging state. For the purpose of full extension of the work gloves 1,2, it is common practice to insert a stretching device 3 into the respective work glove 1,2 for the decontamination phase.

Advantageously, the operator 8 is equipped with virtual reality glasses 80, which may be intended inter alia to display to the operator 8, according to the cleaning and disinfection program saved in the computer unit 5, the prescribed intensity for the surface cleaning, for example as single or multiple wiping to be carried out with a minimum application pressure, and the proper fulfillment thereof, for example as a color change from red to green when reaching fulfillment.

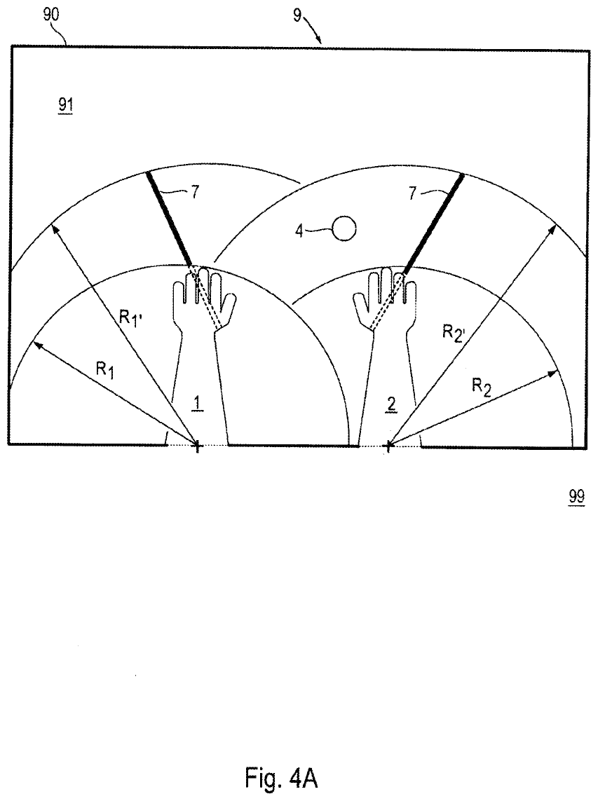

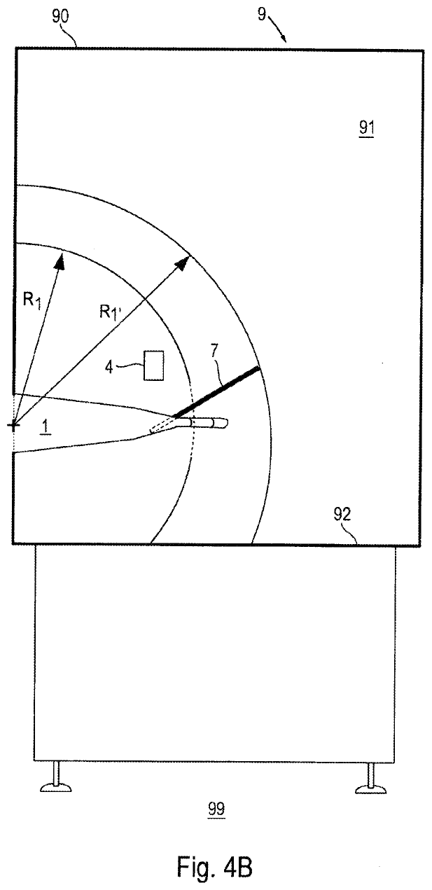

FIGS. 4A and 4B

The work glove 1,2 respectively projecting into the work chamber 91 can be extended as far as a maximum gripping range R1,R2 in the three spatial axes x,y,z. When objects 7 are being held by the work gloves 1,2, there is a maximally extended action range R1′,R2′ in the three spatial axes x,y,z.

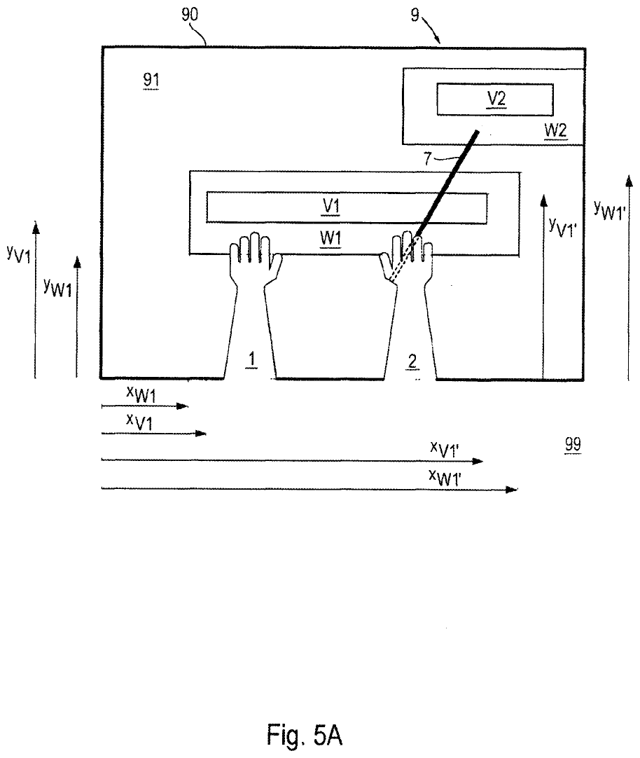

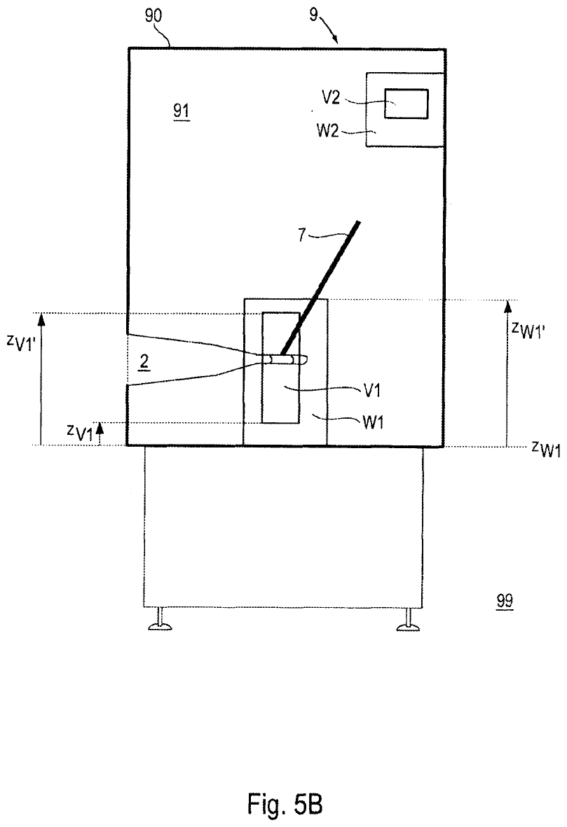

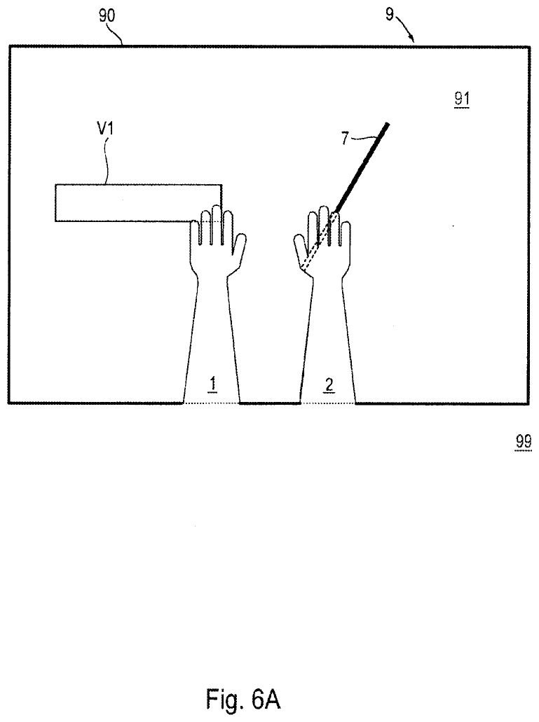

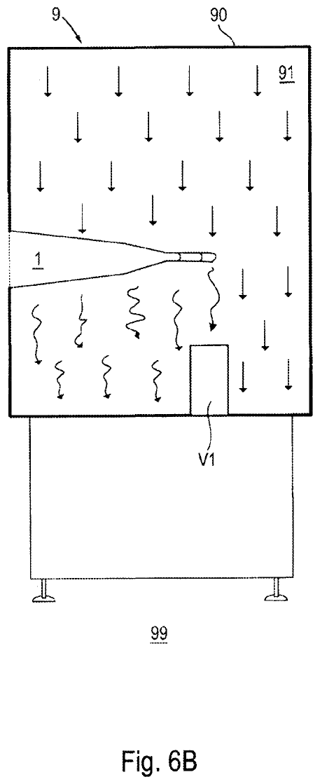

FIGS. 5A to 6B

At least one three-dimensional or two-dimensional prohibited region V1,V2, which may be adjoined by a warning region W1,W2, is defined in the work chamber 91. Individual surface sections or the entire bottom 92 of the containment 9 may be defined as a prohibited region V1,V2. A prohibited region V1,V2, optionally preceded by a warning region W1,W2, may be set up around machines which are installed in the work chamber 91 and which represent a hazard for the operator 8.

The coordinates of a prohibited region V1,V2 and warning region W1,W2 in the three spatial axes x,y,z with xV1,yV1,zV1 to xV1′,yV1′,zV1′ by way of example for the first prohibited region V1 and xW1,yW1,zW1 to xW1′,yW1′,zW1′ by way of example for the first warning region W1 are stored in the computer unit 5. The prohibited region V1,V2 must not be intervened in with the work gloves 1,2, while the warning region W1,W2 should not be intervened in with the work gloves 1,2. The same applies for an object 7, with which the prohibited region V1,V2 must also not be penetrated into, while this should not be done for the warning region W1,W2. A real-time comparison with the prohibited regions V1,V2 and optional warning regions W1,W2 established in the computer unit 5 is carried out in the computer unit 5.

With the tracking system C1-C3, it is also possible to establish and log when, although a prohibited region V1 is not directly intervened in, the laminar flow is nevertheless possibly perturbed to a critical extent over a prohibited region V1 by a work glove 1 projecting in thereover.

The virtual reality glasses 80 which the operator 8 wears are, in particular, intended to display to the operator 8 the prohibited regions V1,V2 and optional warning regions W1,W2 defined in the computer unit 5 as graphics elements.

The signal unit 6 belonging to the arrangement has the purpose, for an operator 8 intervening in the work chamber 91 and/or a monitoring person 8′, in the event of unallowed penetration into a prohibited region V1,V2, of alerting them acoustically and/or optically and/or by a vibration acting on the body of the operator 8 and/or of the monitoring person 8′.

If warning regions W1,W2 are set up, the signal unit 6 is used to inform of the critical penetration into a warning region W1,W2 as an approach to a prohibited region V1,V2 acoustically and/or optically and/or by a vibration acting on the body of the operator 8 and/or of the monitoring person 8′.

1. An arrangement for monitoring a state and movement sequence in an aseptic work chamber of a containment located in an installation room, having at least one work glove which projects into the work chamber, wherein the respective work glove can be extended in the work chamber as far as a maximum gripping range in the three spatial axes, wherein:
a) the arrangement comprises a tracking system, the recordings of which are used for continuous three-dimensional localization of the at least one work glove and are stored in a computer unit; and
b) at least one three-dimensional or two-dimensional prohibited region, which may be adjoined by a warning region, is defined in the work chamber; wherein:
ca) individual surface sections or the entire bottom of the containment may be defined as a prohibited region;
cb) a prohibited region, optionally preceded by a warning region, may be set up around machines which are installed in the work chamber and which represent a hazard for the operator;
cc) the coordinates of the prohibited region and warning region are stored in the computer unit;
cd) the prohibited region must not be intervened in with the at least one work glove; and
ce) the warning region should not be intervened in with the at least one work glove.

2. The arrangement as claimed in claim 1, wherein:
a) each work glove may respectively hold an object or two work gloves together may hold an object, so that there is a maximally extended action range in the three spatial axes;
b) the recordings of the tracking system are used for continuous three-dimensional localization both of the at least one work glove and of the at least one object; wherein
ca) the prohibited region must also not be intervened in with the at least one object; and
cb) the warning region should also not be intervened in with the at least one object.

3. The arrangement as claimed in claim 1, wherein:
a) the spatial positions of work gloves and objects within the xyz coordinate system formed by the three spatial axes are recorded with a timestamp in the computer unit; and
b) a real-time comparison with the prohibited regions and optional warning regions established in the computer unit is carried out in the computer unit.

4. The arrangement as claimed in claim 1, wherein:
a) containers which are filled with substances, are to be filled therewith or are to be emptied, are temporarily located in the work chamber; wherein
b) the spatial positions of the containers within the xyz coordinate system formed by the three spatial axes are recorded with a timestamp in the computer unit in order, in the event of an accident, to establish an unplanned position of a container, possible breakage of a container with its spreading region and the spreading region of uncontrolledly emerging substance.

5. The arrangement as claimed in claim 1, wherein the operator is equipped with virtual reality glasses, which are intended:
a) to display the prohibited regions and optional warning regions defined in the computer unit to them as graphics elements; and
b) to display to them a surface to be cleaned according to the cleaning and disinfection program saved in the computer unit.

6. The arrangement as claimed in claim 1, wherein the tracking system comprises at least:
a) a first camera, which has a first acquisition angle; and
b) a second camera, which has a second acquisition angle; wherein:
ca) the first camera with its first acquisition angle monitoringly records two spatial axes and the second camera with its second acquisition angle monitoringly records the third spatial axis;
cb) the first acquisition angle and the second acquisition angle overlap so that all regions in the work chamber are recorded by the monitoring; and
cc) the recorded states and movement sequences are stored as 3D data and/or video streams in the computer unit.

7. The arrangement as claimed in claim 6, wherein in the case of a large spatial extent of the work chamber, a third camera with its third acquisition angle and, depending on the size of work chamber, further cameras with the respective acquisition angles are installed; wherein:
a) the first camera with its first acquisition angle monitoringly records the first spatial axis, the second camera with its second acquisition angle monitoringly records the second spatial axis and the third camera with its third acquisition angle monitoringly records the third spatial axis;
b) the acquisition angles overlap in such a way that all regions in the work chamber are recorded by the monitoring; and
c) the recorded states and movement sequences are stored as 3D data and/or video streams in the computer unit.

8. The arrangement as claimed in claim 1, wherein a signal unit is provided, which for an operator intervening in the work chamber and/or a monitoring person:
a) in the event of unallowed penetration into a prohibited region, alerts them acoustically and/or optically and/or by a vibration acting on the body of the operator and/or of the monitoring person; and
b) if warning regions are set up, in the event of critical penetration into a warning region as an approach to a prohibited region, informs them acoustically and/or optically and/or by a vibration acting on the body of the operator and/or of the monitoring person.

9. The arrangement as claimed in claim 7, wherein further rules are defined in the computer unit, namely:
a) operators authorized to intervene in the work chamber;
b) objects, for example tools, allowed in the work chamber and allowed fittable components, for example shaped parts for filling machines, and the specification-compliant installing of such shaped parts in respect of plant-technological allocation and positioning;
c) maximum allowed speed of the work gloves or objects moved in the work chamber; and
d) a cleaning and disinfection program.

10. The arrangement as claimed in claim 9, wherein the tracking system is additionally configured to detect the biometric features of an operator positioned at the containment.

11. The arrangement as claimed in claim 5, wherein the virtual reality glasses display to the operator, according to the cleaning and disinfection program saved in the computer unit, the prescribed intensity for the surface cleaning, for example as single or multiple wiping to be carried out with a minimum application pressure, and the fulfillment thereof, for example as a color change from red to green when reaching fulfillment.

12. The arrangement as claimed in claim 1, wherein:
a) the at least one work glove is provided with systematically distributed marking points; and
b) with the aid of said marking points, the volume body formed by the work glove can be recorded as a CAD wire model by the tracking system.

13. The arrangement as claimed in claim 2, wherein:
a) the object held by the at least one work glove is provided with systematically distributed marking points; and
b) with the aid of said marking points the volume body formed by the object can be recorded as a CAD wire model by the tracking system.
